(19) United States
(12) Patent Application Publication
(10) Pub. No.: US 2021/0285829 A1
(43) Pub. Date: Sep. 16, 2021

(54) Temperature Indicator

(71) Applicants: SEB S.A., Ecully (FR); Centre National de la Recherche Scientifique (CNRS), Paris (FR)

(72) Inventors: Anne Teissier, Annecy (FR); Michel Fontaine, Sales (FR); Stéphane Jobic, Nantes (FR); Isabelle Joutang, La Motte Servolex (FR); Erwan Leysour De Rohello, Combs-La-Ville (FR); Stéphanie Le Bris, Chambery (FR); Jean Waku, Chambery (FR)

(73) Assignees: SEB S.A., Ecully (FR); Centre National de la Recherche Scientifique (CNRS), Paris (FR)

(21) Appl. No.: 17/257,722

(22) PCT Filed: Jul. 1, 2019
(86) PCT No.: PCT/EP2019/067616

§ 371 Date: Jan. 4, 2021

(30) Foreign Application Priority Data
Jul. 6, 2018 (FR) 1856226

(51) Int. Cl. G01K 11/14

(52) U.S. Cl. CPC G01K 11/14; G01K 2207/08

(57) ABSTRACT

The invention relates to a coating comprising at least one functional decorative layer. The decorative layer comprises a thermochromic composition exhibiting a reversible variation of optical and/or colorimetric properties when part or all of the coating is subjected to a temperature variation between a cold temperature and a hot temperature, the cold temperature being between 0° C. and 40° C. and the hot temperature being between 80° C. and 400° C., and comprising at least one thermochromic compound of the family of silver halides. The invention also relates to a functional decorative layer composition, to an article comprising the coating or the decorative layer composition, and to the use of the coating or the decorative layer composition as a temperature indicator.

This invention relates in general to coatings comprising at least one functional decorative layer, to compositions of functional decorative layers, to items comprising such coatings and compositions as well as to the use of such coatings and compositions as temperature indicators.

“Decorative layer” denotes, within the meaning of this invention, a decoration that makes it possible to guide the user of the item comprising the decoration in its use.

This invention concerns the field of heating appliances and particularly that of small-scale home heating equipment.

“Heating equipment” denotes, within the meaning of this invention, an item whose temperature increases during its use. Such an item can either be an item with its own heating system or an item that is heated by an external heating system. In addition, such an item is capable of transmitting the calorific energy supplied by the heating system to another material or object in contact with said item.

“Small-scale home heating equipment” denotes, within the meaning of this invention, cooking utensils and small home appliances.

It is essential for a user to see the change in temperature of an item while using it if this item is subjected to heating. For cooking utensils, appropriate temperature control when cooking food is necessary for health and flavor reasons (for example when browning a steak on a griddle or in a pan), but also to prevent occasional overheating that deteriorates the coating of the cooking utensil. Material that is overheated less often will last longer. Food cooked at lower temperatures will have healthier organoleptic characteristics. Moreover, cooking the strictly minimum temperature necessary helps reduce energy consumption and therefore the environmental impact.

The Applicant's French patent FR 1388029 describes a cooking utensil equipped with a temperature indicator consisting of a thermosensitive body that reversibly changes color according to the temperature, this temperature indicator being formulated in a non-stick coating, in particular comprised of polytetrafluoroethylene. A thermostable pigment can also be incorporated into the cooking utensil as a reference to make it possible to assess the relative change in the color of the temperature indicator and thus of the temperature change. However, simply combining a thermostable pigment and a thermosensitive pigment does not make it possible to clearly distinguish the temperature change.

To remedy these problems, the Applicant then developed a temperature indicator based on thermochromic pigments, described in European patent EP 1121576. This temperature indicator is a decoration comprising at least two patterns, one based on a thermochromic iron oxide pigment that darkens as the temperature increases, the other based on a thermochromic pigment that lightens as the temperature increases and comprising a blend of perylene red and black spinel. As a result, at a pre-set temperature the colors from both patterns mix together, which is one way for the user to identify the pre-set temperature.

The simultaneous use of these two thermochromic pigments in contiguous areas of a decoration does make it possible to improve the visual perception of the change in the surface temperature of the cooking utensil. However, this type of temperature indicator is still hard for the user to grasp at first as both areas are red and have chromatic values that are similar at room temperature. Moreover, the colors in the patterns mix within a temperature range of at least 50° C. This makes it difficult to read and assess the temperature change, particularly for an untrained person. Users thus tend to overlook the information provided by this temperature indicator.

There is therefore an advantage in being able to provide a temperature indicator that clearly changes color and/or optical properties when there is a temperature change, for example by showing colors that are obviously different in the case of a color-based temperature indicator (turning from yellow to orange, for example.)

These types of pigment were the subject-matter of French patent FR 2891844 in which CuMoW oxides showed reversible color changes when there was a temperature change and/or when subjected to mechanical stress, for example a pressure of over 105 Pa. However, these oxides, which change color as a result of a change of phase, are particularly sensitive to cyclability. Thus, after five or more cycles it was no longer possible to return to the alpha metastable phase that resulted in the green coloration at low temperatures. Such a pigment is of no practical interest as a colored temperature indicator for repeated use such as when cooking food.

Furthermore, there are also known semiconductors (SCs) whose properties indicate a gradual color change in a white-yellow-orange-red-black sequence when the temperature increases. “Thermochromic semiconductor (SC)” denotes a semiconductor compound that changes color when the temperature rises. The gradual and fully-reversible thermochromic nature of these semiconductor compounds is due to the reduction in the width in the forbidden band of the semiconductor due to the material's dilatation. In this temperature range, SC color changes are few and hardly noticeable and are limited to the following changes: pale yellow to bright yellow (Bi₂O₃), bright yellow to orange-yellow (BiVO₄), orange-yellow to orange-red (V₂O₅), orange-red to very dark red (Fe₂O₃), etc. It can therefore be seen that, even if it is possible to reach other colors than red, the perception of the thermochromic effect is still difficult and imprecise.

European patents EP 0287336 and EP 1405890 disclose the development of blends comprising one or several thermochromic semiconductors and one or several stable pigments in order to obtain complex compositions with enhanced thermochromic properties. More particularly, in patent EP 1405890, (thermochromic) bismuth oxide Bi₂O₃ is combined with CoAl₂O₄ (thermostable, blue in color) in a 15:1 ratio, with the pigments bound by potassium silicate. The coating containing this blend is blue at room temperature and turns orange at 400° C. However, bismuth oxide is not easy to use and a sensitivity to hot oils has been observed, which causes the pigment to blacken.

To remedy the problems of the functional coatings known in the prior art, this invention aims to provide the user with a coating comprising at least one decorative functional layer that makes it possible to assist and guide the user of the item on which the coating in question is deposited.

Therefore, this invention relates to a coating comprising at least one decorative functional layer, in which:
The decorative layer comprises a thermochromic composition presenting reversible changes in the optical and/or colorimetric properties when the coating is subjected, partially or fully, to a change in temperature between a cold temperature and a hot temperature, the cold temperature being comprised between 0° C. and 40° C. and the hot temperature being comprised between 80° C. and 400° C., and in which
The thermochromic composition comprises at least one thermochromic compound in the silver halide family.

“Thermochromic compound” or “thermochromic pigment” denotes, within the meaning of this invention, an organic or mineral compound that presents a reversible change in the optical and/or colorimetric properties when the temperature increases or decreases.

“Thermochromic composition” denotes, within the meaning of this invention, a composition that changes optical and/or colorimetric properties according to the temperature, with this change being reversible.

Advantageously, the thermochromic compound can be chosen among silver bromide, silver iodide.

The use of silver iodide as a thermochromic compound makes it possible to obtain marked thermochromism with a sharp transition temperature of about 147° C. Other advantages of this thermochromic compound are its high compatibility, in particular with fluorocarbon resins or sol/gel materials, and its oil-resistant nature which limits the use of protective casings as is the case, for example, with bismuth oxide derivatives.

The decorative layer of coating according to the invention comprises a thermochromic composition presenting a reversible change in the optical and/or colorimetric properties when the coating is subjected, partially or fully, to a change in temperature between a cold temperature (comprised between 0° C. and 40° C.) and a hot temperature (comprised between 80° C. and 400° C.)

Advantageously, this hot temperature can be comprised between 120° C. and 280° C.

In the thermochromic composition, the thermochromic compound in the halide family can be combined with other thermochromic compounds and/or thermostable pigments in order to expand the range of available hues, so as to improve the perception of the change in hue and so that the final result is within the sensitivity range of the human eye and enables the user to obtain a decoration that is even easier to read.

Advantageously, the thermochromic composition according to the invention can also comprise at least one other thermochromic compound. For example, said thermochromic composition can also comprise at least one thermochromic semiconductor compound, which can be chosen among Bi₂O₃, Fe₂O₃, VO₂, V₂O₅, WO₃, CeO₂, In₂O₃, the pyrochlore semiconductor Y_{1,84}Ca_{0,16}Ti_{1,84}V_{0,16}O_{1,84}, BiVO₄ and mixtures thereof.

Advantageously, the thermochromic composition according to the invention can also comprise at least one other thermostable pigment.

“Thermostable pigment” denotes, within the meaning of this invention, an organic or mineral compound that presents a very slight change of hue when subjected to a temperature increase or decrease within a given temperature range, or even no change of color.

Preferably, the thermostable pigment can be chosen among titanium dioxide, spinels, iron oxides, perylene red, dioxazine purple, mixed aluminum and cobalt oxides (such as cobalt aluminate (CoAl₂O₄)), carbon black, chromium oxides and copper oxides, chromium titanate, antimony, nickel titanate, aluminosilicates, various metal-based inorganic pigments with crystalline spinel structure and mixtures thereof.

According to a first embodiment of the coating according to the invention, the decorative layer can be binder-free.

According to a second embodiment of the coating according to the invention, the decorative layer can comprise, in addition to the thermochromic composition, at least one binder, preferably a thermostable binder.

Within the meaning of this invention, “thermostable binder” denotes a binder that can withstand at least 200° C.

The binder can comprise at least one of an enamel, a fluorocarbon resin, a resin adhesive, an inorganic or hybrid organic-inorganic polymer synthetized by sol/gel method (a sol/gel material), a lacquer, a condensed tannin.

The binder can comprise at least one enamel, one fluorocarbon resin, one resin adhesive, one inorganic or hybrid organic-inorganic polymer synthetized by sol/gel method (a sol/gel material), one lacquer, one condensed tannin.

Advantageously, said binder can comprise one fluorocarbon resin and at least one resin adhesive and/or at least one condensed tannin.

The fluorocarbon resin can be chosen in the group comprising polytetrafluoroethylene (PTFE), tetrafluoroethylene and perfluoromethylvinylether copolymers (such as MFA), tetrafluoroethylene and perfluoropropylvinylether copolymers (such as PFA), tetrafluoroethylene and hexafluoropropylene copolymers (such as PFA) and mixtures thereof.

The resin adhesive can be chosen in the group comprising polyether ketones (PEKs), polyether ether ketones (PEEKs), polyamide-imides (PAIs), polyether-imides (PEIs), polyimides (PIs) polyether sulfones (PESUs), polyphenylene sulfides (PPS), polybenzimidazoles (PBIs).

The condensed tannin can have as its basic pattern one or several flavan-3-ol and/or flavan-3,4-diol and/or phlorotannin monomer unit(s).

Advantageously, said binder can comprise a condensed tannin, preferably having as a basic pattern one or several flavan-3-ol and/or flavan-3,4-diol and/or phlorotannin monomer unit(s).

Advantageously, said binder can comprise a sol/gel composition obtained by hydrolyzing a metal alkoxide-type sol/gel precursor, by introducing water and an acid or basic catalyst, then by condensation.

The metal alkoxide-type sol/gel precursor can be chosen among the group comprising the following compounds:
Precursors corresponding to the general formula M₁(OR₁)ₙ,
Precursors corresponding to the general formula M₂(OR₂)₍ₙ₋₁₎R_{2′}, and
Precursors corresponding to the general formula M₃(OR₃)₍ₙ₋₂₎(R_{3′})_{2′},

### Wherein:

R₁, R₂, R₃ or R_{3′} denotes an alkyl group,
R_{2′} denotes an optionally-functionalized alkyl group or an optionally-functionalized phenyl group,
n is an integer corresponding to the maximum valence of M₁, M₂ or M₃,
M₁, M₂ or M₃ denote an element chosen among Si, Zr, Ti, Sn, Al, Ce, V, Nb, Hf, Mg, or the lanthanides (Ln).

Preferably, the metal alkoxide-type sol/gel precursor can be an alkoxysilane, which can be chosen in the group comprising methylmethoxysilane (MTMS), methyltriethoxysilane (MTES) tetraethoxysilane (TEOS), tetramethoxysilane (TMOS), and (3-glycidoxypropyl)trimethoxysilane (GLYMO), aminopropyltriethoxysilane (APTES) and mixtures thereof.

Advantageously, said binder can comprise an enamel that can mostly comprise silicon oxide and titanium oxide, mixed with fluxes chosen among iron oxides, vanadium oxides, boron oxides, sodium oxides, potassium oxides.

Advantageously, said binder can comprise an enamel that can be chosen among silicone, polyester, silicone-polyester lacquers.

Advantageously, the ratio of the dry content of the thermochromic composition to the dry content of the binder can be less than 3, preferably less than 2.25, preferably less than or equal to 2, preferably less than or equal to 1.

Such a thermochromic composition/binder ratio in the decorative layer seems to have a significant effect on the stability of the color of the silver iodide.

Advantageously, the binder can comprise at least one fluorocarbon resin.

The use of a fluorocarbon resin, and in particular PTFE, in the decorative layer seems to provide a protective effect on the thermochromic compound against stress such as heat or hot oil.

Advantageously, the binder can comprise at least one fluorocarbon resin and the ratio of the dry content of the thermochromic composition to the dry content of the fluorocarbon resin can be less than 3, preferably less than 2.25, preferably less than or equal to 2, preferably less than or equal to 1.

Such a thermochromic composition/fluorocarbon resin ratio in the decorative layer seems to have a significant effect on the stability of the color of the silver iodide.

“Layer” denotes, within the meaning of this invention, a continuous or discontinuous layer. A continuous layer (also known as a monolithic layer) is a single whole forming a totally solid color that completely covers the surface on which it is deposited. A discontinuous layer (or non-monolithic layer) can comprise several parts and is thus not a single whole.

Advantageously, the decorative layer according to the invention can be continuous or discontinuous. Of course, the decorative layer can have any shape, such as concentric circles, letters or drawings. The decorative layer, when continuous, can cover the entire surface of the support.

The coating according to the invention can also comprise other layers of decoration. The decoration thus created can comprise at least two patterns. According to a first variant, one of the two patterns contains a chemical compound that darkens with the rise and fall of the temperature and the other pattern contains a chemical compound that lightens with the rise and fall of the temperature. Thus, the contrast created between the two patterns makes it possible to ascertain the temperature change better. According to another variant, one of the two patterns comprises at least one thermochromic compound and the other pattern comprises at least one thermostable pigment.

These other decorative layers can comprise at least one thermochromic compound and/or at least one thermostable pigment, with or without binder.

Advantageously, the coating according to this invention can be a non-stick coating. The terms “non-stick” or “non-adhesive” are used indiscriminately herein.

Advantageously, the coating according to this invention can be thermostable.

Within the meaning of this invention, a thermostable coating is a coating that can withstand at least 200° C.

Advantageously, the coating according to the invention can comprise in addition to the functional decorative layer:
At least one first layer applied directly to the support, also known as an undercoat or a tack coat or a primer coat or a primer.
   Preferably, this layer should adhere well to the support and contribute all of its mechanical properties to the coating (such as, for example, hardness, scratch resistance); and/or
At least one continuous and transparent surface layer also known as a finishing coat or finish, this layer allowing for full visibility of the functional decorative layer while protecting it from abrasion. This layer can also confer its non-stick properties to the coating.

The coating according to the invention can be an organic-mineral coating or a fully mineral coating.

“Organic-mineral coating” denotes, within the meaning of this invention, a coating with an essentially inorganic network but which comprises organic groups, in particular due to the precursors used and to the temperature at which the coating was fired or due to the incorporation of organic loads.

“Fully mineral coating” denotes, within the meaning of this invention, a coating made of a completely inorganic material, free of any organic group. Such a coating can be obtained by the sol/gel method with a firing temperature of at least 400° C. or from tetraethoxysilane (TEOS) precursors with a firing temperature that can be less than 400° C.

It is foreseen that said binder is present either in the undercoat or in the functional decorative coat or in the finishing coat or in all three coats or in two out of the three coats.

Preferably, these various layers (thus their respective binders) are compatible with each other. But it is not absolutely essential for the binders to be identical in all of the layers. Thus, it is possible to have a silicone resin binder in the functional decorative layer, while the undercoat and/or finishing coat is a sol/gel material.

This invention also relates to a functional decorative layer composition comprising:
a thermochromic composition presenting a reversible change in the optical and/or colorimetric properties when the functional decorative layer is subjected, partially or fully, to a change in temperature between a cold temperature and a hot temperature, the cold temperature being comprised between 0° C. and 40° C. and the hot temperature being comprised between 80° C. and 400° C., and comprising at least one thermochromic compound in the silver halide family and
at least one binder.

The thermochromic compound, the hot temperature, the other thermochromic compound, the thermostable pigment, the binder of the decorative layer composition according to the invention are as defined in reference to the coating according to the invention.

Advantageously, the binder of the decorative layer composition according to the invention can comprise at least one fluorocarbon resin.

Advantageously, the ratio of the dry content of the thermochromic composition to the dry content of the binder can be less than 3, preferably less than 2.25, preferably less than or equal to 2, preferably less than or equal to 1.

Advantageously, the binder can comprise at least one fluorocarbon resin and the ratio of the dry content of the thermochromic composition to the dry content of the fluorocarbon resin can be less than 3, preferably less than 2.25, preferably less than or equal to 2, preferably less than or equal to 1.

This invention also relates to an item comprising at least one coating according to the invention or at least one functional decorative layer composition according to the invention.

Advantageously, the item can comprise a support with two opposite sides, at least one of which is covered with a coating according to the invention.

Various types of small-scale home heating equipment in accordance with the invention can be foreseen, with various shapes and made of various materials.

Thus, depending on the conditions of use and the required heat treatments, the supports can be chosen among supports made of metallic material, glass supports, ceramic supports, earthenware supports, plastic supports.

Advantageous examples of the metallic supports that can be used in this invention are supports made or not of anodized aluminum, optionally polished, brushed, sanded, bead-blasted or sandblasted, aluminum alloy supports anodized or not, optionally polished, brushed, sanded or sandblasted, steel supports optionally polished, brushed, sanded, bead-blasted or sandblasted, stainless-steel supports optionally polished, brushed, sanded or sandblasted, tempered steel, aluminum or iron supports, copper supports optionally hammered or polished.

Advantageously, the support can be chosen among supports comprising layers of ferritic stainless steel/aluminum/austenitic stainless steel, supports comprising layers of stainless steel/aluminum/copper/austenitic stainless steel, basins made of aluminum castings, of aluminum or of aluminum alloy lined with a stainless steel outer bottom, roll-bonded supports, for example dual-layer roll-bonded supports comprising a stainless-steel layer (for example intended to be the inner side of the item) and an aluminum or aluminum alloy layer, anodized or not (for example intended to be the outer side of the item).

Advantageously, the item can be a heating item, and in particular an item of small home heating equipment.

The item of small home heating equipment according to this invention can in particular be a cooking utensil or a small appliance such as a clothes iron, a hair care tool, an insulated pot (for example a coffee pot) or a mixing bowl.

The item of small home heating equipment according to this invention can in particular be a cooking utensil, particularly a cooking utensil in which one of the two opposite sides of the support is an inner side, optionally concave, intended to be placed next to food that may be introduced in or on the item, and the other side is an outer side, optionally convex, intended to be placed near a source of heat.

Non-limiting examples of cooking utensils in accordance with this invention include cooking utensils such as pots and pans, woks and skillets, stewpots and cauldrons, crepe pans, waffle irons, griddles, baking molds and sheets, planchas, barbecue grills and trays, raclette or fondue pots, rice cookers, jam cookers, bread machine tubs, mixing bowls.

The small home heating equipment according to this invention can in particular be a clothes iron, such as a steam iron or steam ironing unit, and the support coated according to this invention is the iron's soleplate.

The small home heating equipment according to this invention can in particular be a hair care tool, such as a curling iron or smoothing iron, and the support coated according to this invention is the one of the heating plates of the hair care tool.

This invention also relates to the use of the coating according to this invention, or of the functional decorative layer composition according to this invention, as a temperature indicator, in particular on a heating item.

This invention also relates to the method for preparing a coating according to the invention on at least one of the sides of a support, characterized in that it comprises the following steps:
a) Preparing the thermochromic composition comprising the thermochromic compound in the silver halide family;
b) Preparing a functional decorative layer composition comprising the thermochromic composition;
c) Applying the decorative layer composition on the side of the support to form a functional decorative layer; and
d) Firing.

Advantageously, the functional decorative layer composition can also comprise a binder, preferably a thermostable binder.

Advantageously, the method for preparing a coating according to this invention can also comprise the application of at least one finishing coat on the decorative layer between steps c) and d).

Advantageously, the side of the support, on which the decorative layer composition in step c) is applied, can have been previously coated with at least one undercoat.

The decorative layer can be applied on the support using any appropriate method known to the person skilled in the art, and in particular screen printing, spraying, using a roller, pad printing, by means of a screen or digital printing.

“Digital printing” denotes, within the meaning of this invention, printing carried out directly using computer data in continuous flow between a computer and a printing machine.

Advantageously, digitally printing the thermostable coating according to the invention is performed using an ink jet method.

Other advantages and special features of this invention will be seen in the following description, which is provided as a non-limiting example and refers to the figures appended hereto:

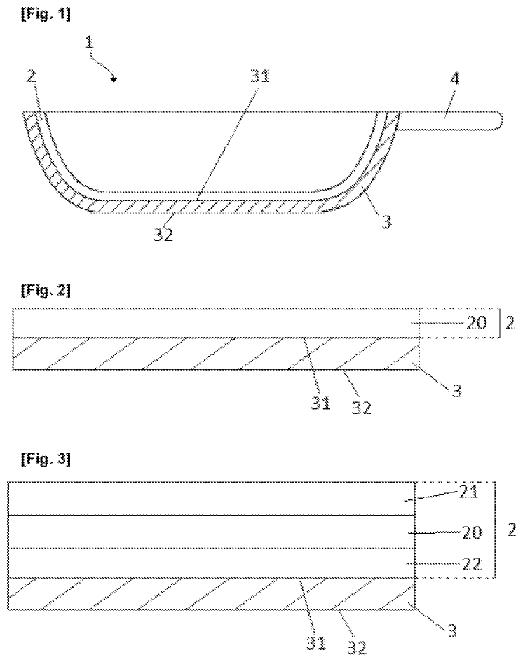

FIG. 1 is a schematic cross-section view of an example of an embodiment of a pan according to the invention;

FIG. 2 is a schematic cross-section view of the pan in FIG. 1 with an example of a single-layer coating according to the invention; and

FIG. 3 is a schematic cross-section view of the pan in FIG. 1 with an example of a multi-layer coating according to the invention.

FIG. 1 shows an example of a cooking utensil according to the invention, a pan 1 comprising a support 3 shown as a shallow bowl equipped with a handle 4. The support 3 comprises an inner side 31 which is the side turned towards the food that may be placed in the pan 1, and an outer side 32 that is to be placed near an external source of heat. Support 3 comprises, on its inner side 31, a coating 2 according to the invention.

FIG. 2 is a schematic cross-section view of the pan in FIG. 1 with an example of a single-layer coating 2 according to the invention. The coating 2 comprises a decorative layer 20 comprising at least one thermochromic component in the silver halide family.

FIG. 3 is a schematic cross-section view of the pan in FIG. 1 with an example of a multi-layer coating 2 according to the invention. The coating 2 comprises an undercoat 22, a finishing coat 21 and a decorative layer 20 comprising at least one thermochromic component in the silver halide family. The invention is illustrated in greater detail in the following examples.

### EXAMPLES

### Example 1: Preparation of an AgI-Based Decorative Layer Composition, with No Thermostable Binder

A decorative AgI-based layer composition with no thermostable binder is prepared from the components listed below:

| Components | Weights (g) |
|---|---|
| Water | 52.73 |
| AgI | 30.64 |
| Thickener | 4.90 |
| pH adjuster | 0.69 |
| Solvent | 11.04 |

A decorative paste is prepared first by dispersing the AgI in the water.

Then the decorative layer composition is prepared by mixing the decorative paste with the other components.

### Example 2: Preparation of an AgI-Based Decorative Layer Composition, with No Thermostable Binder

A decorative layer composition comprising AgI with no thermostable binder is prepared from the components listed below:

| Components | Weights (g) |
|---|---|
| Water | 50.0 |
| AgI | 37.5 |
| Thickener | 5 |
| pH adjuster | 0.5 |
| Solvent | 7 |

A decorative paste is prepared first by dispersing the AgI in the water.

Then the decorative layer composition is prepared by mixing the decorative paste with the other components.

### Example 3: Preparation of an AgI-Based Decorative Layer Composition with a Thermostable Binder

A decorative AgI-based layer composition with a thermostable binder, PTFE, is prepared from the components listed below:

| Components | Weights (g) |
|---|---|
| Aqueous dispersion of | 59.06 |
| PTFE (60% dry content | |
| by weight) | |
| AgI | 23.62 |
| Thickener | 2.19 |
| Water | 3.13 |
| pH adjuster | 0.48 |
| Solvent | 11.22 |
| Foam inhibitor | 0.30 |

A decorative paste is prepared first by dispersing the AgI in the water.

Then the decorative layer composition is prepared by mixing the decorative paste with the other components

### Example 4: Preparation of Fluorocarbon Resin-Based Coatings Comprising at Least One Decorative Layer Comprising AgI

Various decorative layer compositions were formulated. These compositions have a common base formulation comprising in particular a solvent, water and thickeners. AgI and PTFE were added to this base formulation in respective proportions which are detailed below. The decorative layer compositions are obtained by first dispersing the AgI in water, then mixing the paste obtained with the other ingredients.

| | Without | PTFE | PTFE | PTFE |
|---|---|---|---|---|
| | PTFE | Content 1 | Content 2 | Content 3 |
| AgI | 10 | 10 | 10 | 10 |
| (dry content in g) | | | | |
| PTFE | 0 | 4.41 | 9.68 | 25.78 |
| (dry content in g) | | | | |
| Ratio AgI/PTFE | n/a | 2.27 | 1.03 | 0.39 |

Each of these compositions was applied by pad printing in one or three or five layers on a PTFE-based primer deposited on a support.

A transparent PTFE-based finish was then deposited and the coating was fired at 430° C. for 11 minutes.

The coatings obtained have a vert-de-gris-colored decoration at room temperature (20° C.) on a black background (corresponding to the undercoat). The coatings for which the decorative layer compositions were deposited in a single layer have a lighter vert-de-gris-colored decoration than the coatings for which the decorative layer compositions were deposited in multiple layers.

Various aging tests were performed on the coatings obtained.

Color-change test: the coated samples were fired to 250° C. A gradual change in the color of the decoration, from the initial vert-de-gris to a yellow/orange color, was observed during heating, with the colorimetric properties of the black background remaining unchanged. The contrast in the color change is most obvious when the decoration comprises PTFE. The samples were left to cool to room temperature; a gradual color change from yellow/orange to the initial vert-de-gris color was observed during cooling, with the colorimetric properties of the black background remaining unchanged.

Peanut oil test at 250° C.: the coated samples were immersed for fifteen hours in peanut oil heated to 250° C. The appearance of the pad-printed areas was examined before and after the test. There was a clear yellowing of the pad-printed areas in the three- and five-layer configurations. Moreover, particular soiling was observed in the three- and five-layer configurations on the pad-printed areas without PTFE and with PTFE content 1 (AgI/PTFE ratio=2.27). The decorative layer compositions comprising an AgI/PTFE ratio<2.27 were protected from soiling.

Water test at 82° C.: the coated samples were immersed for forty-eight hours in water at 82° C. The appearance of the pad-printed areas was examined before and after the test. Uniform whitening was observed in the configurations without PTFE and with PTFE content 1 (AgI/PTFE ratio=2.27). The decorative layer compositions comprising an AgI/PTFE ratio<2.27 seem to have been protected from this effect and the color of the corresponding pad-printed areas was uniform with no defects.

1. A coating, comprising:
at least one functional decorative layer
comprising a thermochromic composition,
wherein the thermochromic composition exhibits reversible changes in the optical and/or colorimetric properties when the coating is subjected, partially or fully, to a change in temperature between a cold temperature and a hot temperature, the cold temperature being between 0° C. and 40° C. and the hot temperature being between 80° C. and 400° C., and
wherein the thermochromic composition comprises at least one thermochromic compound in the silver halide family.

2. The coating according to claim 1, wherein the thermochromic compound is silver bromide or silver iodide.

3. The coating according to claim 1 wherein the hot temperature is between 120° C. and 280° C.

4. The coating according to claim 1, wherein the thermochromic composition comprises at least one other thermochromic compound and/or at least one thermostable pigment.

5. The coating according to claim 1, wherein the decorative layer is free of binder.

6. The coating according to claim 1, wherein the decorative layer comprises at least one binder.

7. The coating according to claim 6, wherein the binder comprises at least an enamel, a fluorocarbon resin, a resin adhesive, an inorganic or hybrid organic-inorganic polymer synthetized by sol/gel method, a lacquer, and a condensed tannin

8. The coating according to claim 6, wherein a weight ratio of the dry content of the thermochromic composition to the dry content of the binder is less than 3.

9. A functional decorative layer, comprising:
a thermochromic composition exhibiting reversible changes in the optical and/or colorimetric properties when the functional decorative layer is subjected, partially or fully, to a change in temperature between a cold temperature and a hot temperature, the cold temperature being between 0° C. and 40° C. and the hot temperature being between 80° C. and 400° C.; and
at least one binder,
wherein the thermochromic composition comprises at least one thermochromic compound in the silver halide family.

10. The functional decorative layer according to claim 9, wherein the thermochromic compound is silver bromide or silver iodide.

11. The functional decorative layer according to claim 9, wherein the hot temperature is between 120° C. and 280° C.

12. The functional decorative layer according to claim 9, wherein the thermochromic composition comprises at least one other thermochromic compound and/or at least one thermostable pigment.

13. The functional decorative layer according to claim 9, wherein the binder comprises at least an enamel, a fluorocarbon resin, a resin adhesive, an inorganic or hybrid organic-inorganic polymer synthetized by sol/gel method, a lacquer, and a condensed tannin.

14. The functional decorative layer according to claim 9, wherein a weight ratio of the dry content of the thermochromic composition to the dry content of the binder is less than 3.

15. An item comprising the coating according to claim 1.

16. (canceled)

17. An item comprising the functional decorative layer according to claim 9.
